(19) United States
(12) Patent Application Publication
(10) Pub. No.: US 2025/0376275 A1
(43) Pub. Date: Dec. 11, 2025

(54) ROBOTIC EAGLES AND BIRD-LIKE ROBOT WITH EMBODIED ARTIFICIAL INTELLIGENCE

(71) Applicant: General Cybernation Group Inc., Rancho Cordova, CA (US)

(72) Inventor: George Shu-Xing Cheng, Folson, CA (US)

(73) Assignee: General Cybernation Group Inc., Rancho Cordova, CA (US)

(21) Appl. No.: 18/740,135

(22) Filed: Jun. 11, 2024

(51) Int. Cl. B64U 10/40; B64C 33/02; B64U 50/38; B64U 101/30; G05D 1/248; G05D 109/20; H02J 7/00; H02J 50/10

(52) U.S. Cl. CPC B64U 10/40; B64C 33/02; B64U 50/38; G05D 1/248; H02J 7/0047; H02J 50/10; B64U 2101/30; B64U 2201/10; G05D 2109/27; H02J 7/00032

(57) ABSTRACT

A robotic eagle and bird-like robot empowered by generative artificial intelligence (Gen-AI) is disclosed, capable of autonomously performing essential tasks such as airport safety and forest fire monitoring. The robotic eagle's lifelike design includes a head, multiple eyes, wings, legs, claws, and a tail, all meticulously crafted to mimic the appearance and flight capabilities of a real bird. The trained AI model functions as the brain, processing detailed environmental data captured by video cameras, audio microphones, and flight sensors to provide guidance commands that control the flying motions. Ensuring continuous operation, the robotic eagle features a wireless battery charging system, allowing it to recharge autonomously in remote locations using solar and wind energy. This technology, made possible by Gen-AI, heralds a new era in environmental monitoring and safety, delivering unprecedented performance and reliability.

### INVENTION

The subject of this patent relates to embodied artificial intelligence, bird-like robots, and guidance and control.

A bird-like robot is an advanced machine designed to resemble and mimic the structure and functionality of birds including eagles. These robots typically include the following key components:

Head: The head houses essential sensory equipment such as cameras for vision, microphones for hearing, and advanced sensors for navigation and environmental awareness. It also includes mechanisms to mimic the movements and rotations of a bird's head.

Body: The central structure that supports and connects all other components. The body contains the main computational units, power supply, and additional sensors for balance, orientation, and environmental interaction.

Wings: Two wings attached to the body, designed to replicate the flapping and gliding motions of bird wings. Each wing consists of multiple segments connected by joints, allowing for a wide range of movements. Actuators and sensors within the wings enable precise control of flight dynamics.

Tail: The tail provides stability and maneuverability during flight. It can include multiple segments with actuators to adjust its position and shape, aiding in direction changes and balance.

Legs and Claws: Two legs connected to the lower part of the body, each ending in claws. These components allow the bird-like robot to perch, walk, and grasp objects. The legs and claws are equipped with actuators and sensors for precise movement and gripping.

Feathers: Artificial feathers attached to the wings and tail, designed to enhance aerodynamic properties and mimic the appearance of real birds. These feathers can be made from lightweight, durable materials and may include sensors to provide feedback on airflow and pressure.

Actuators: Mechanical components that drive movement in the robot's joints. Actuators can be electric motors, hydraulic systems, or pneumatic systems, enabling the robot to perform complex motions such as flapping wings, rotating the head, and moving the legs.

Sensors: Various sensors throughout the robot gather data about the environment and the robot's own state. These include vision sensors (cameras), auditory sensors (microphones), tactile sensors (touch), and proprioceptive sensors (position and movement). Additionally, sensors for detecting airflow, pressure, and altitude are crucial for flight.

Control Systems: The “brain” of the robot, consisting of processors and software that interpret sensor data and control the actuators. Advanced control systems incorporate algorithms for flight dynamics, decision-making, and interaction with the environment. Embodied artificial intelligence enables the robot to learn from its experiences and adapt to new situations.

Power Supply: This component provides the necessary energy for the robot's operation. Power supplies include flexible thin film solar panels and batteries. In addition, a wireless battery charging mechanism is included in the power supply system.

Communication Interfaces: These allow the robot to interact with other systems and humans, using wireless or wired communication technologies. Effective communication interfaces are essential for remote control, monitoring, and data exchange.

Together, these components enable bird-like robots to perform a wide range of tasks, from simple flight maneuvers to complex interactions with their environment. The integration of embodied artificial intelligence allows these robots to adapt and respond to dynamic conditions, making them highly versatile and capable of operating in diverse settings.

The advancement of large language model (LLM) and generative artificial intelligence (Gen-AI) makes it feasible to train a bird-like robot to perform certain tasks with videos, images, and text. Such robots can be developed with embodied AI to fly and achieve tasks such as forest fire monitoring and alarming. In this patent, we describe innovative bird-like robots with embodied artificial intelligence.

In the accompanying drawings:

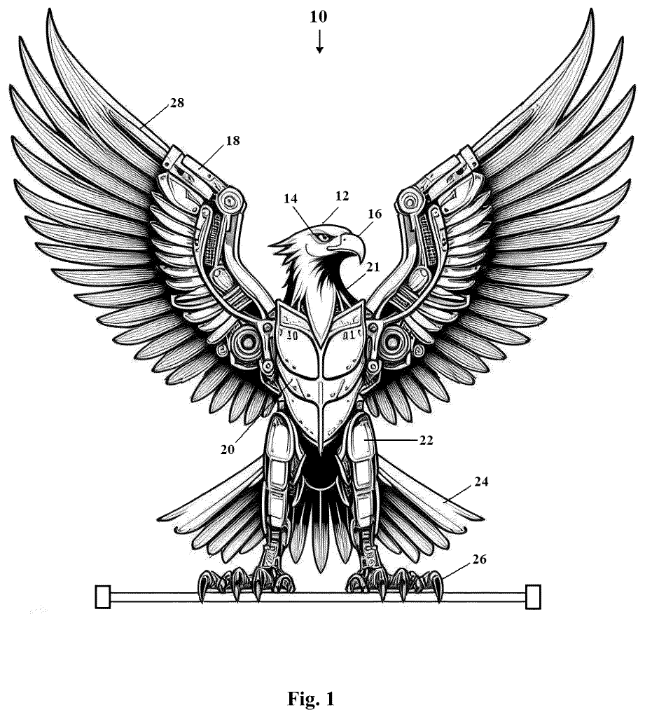

FIG. 1 is a perspective front view of an eagle-like robot with all key components, according to an embodiment of this invention.

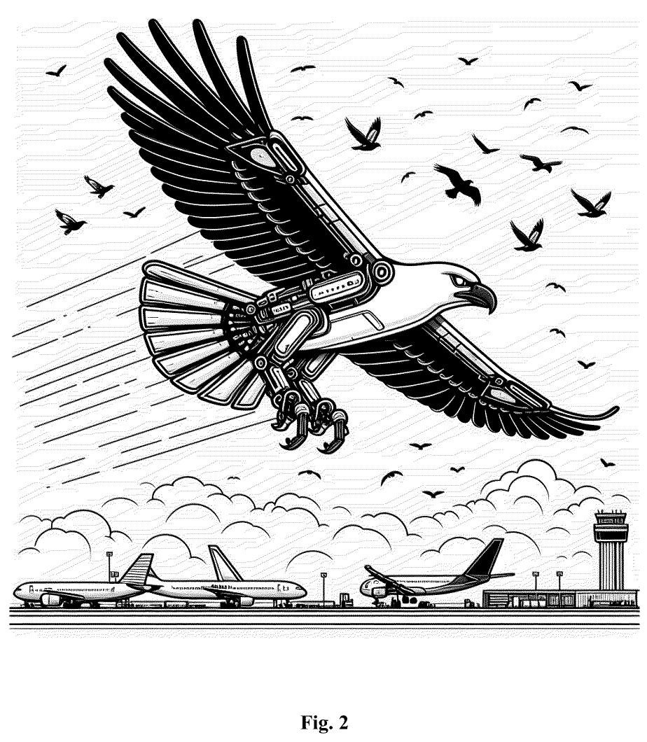

FIG. 2 is a perspective view of a robotic eagle flying around an airport, chasing birds away, according to an embodiment of this invention.

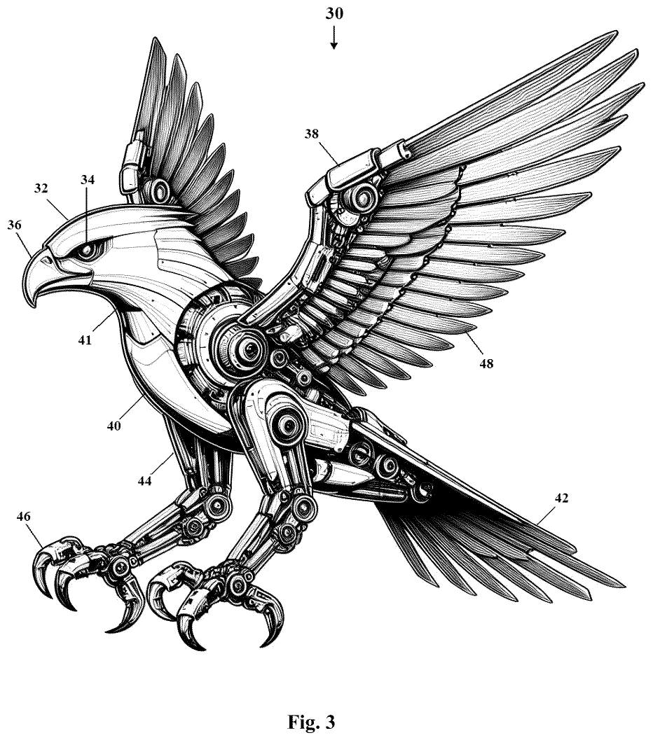

FIG. 3 is a perspective side view of a bird-like robot with all key components, according to an embodiment of this invention.

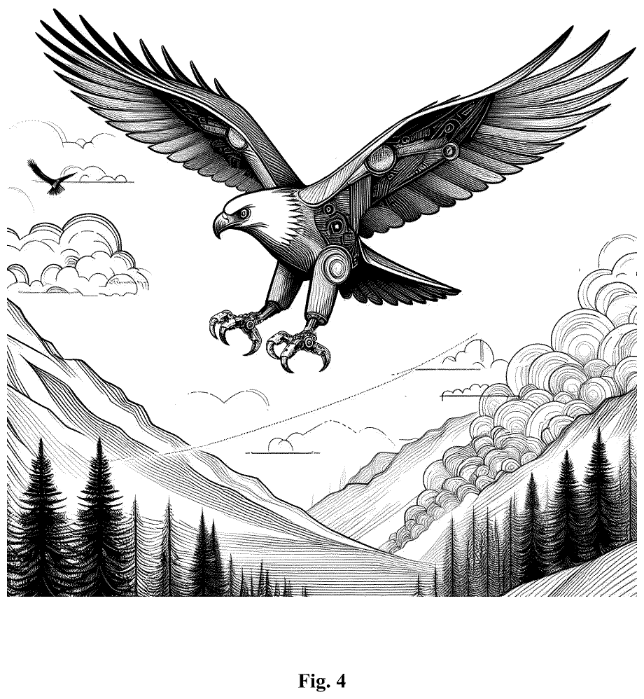

FIG. 4 is perspective view of a robotic bird flying in the sky, monitoring the forest and land below, according to an embodiment of this invention.

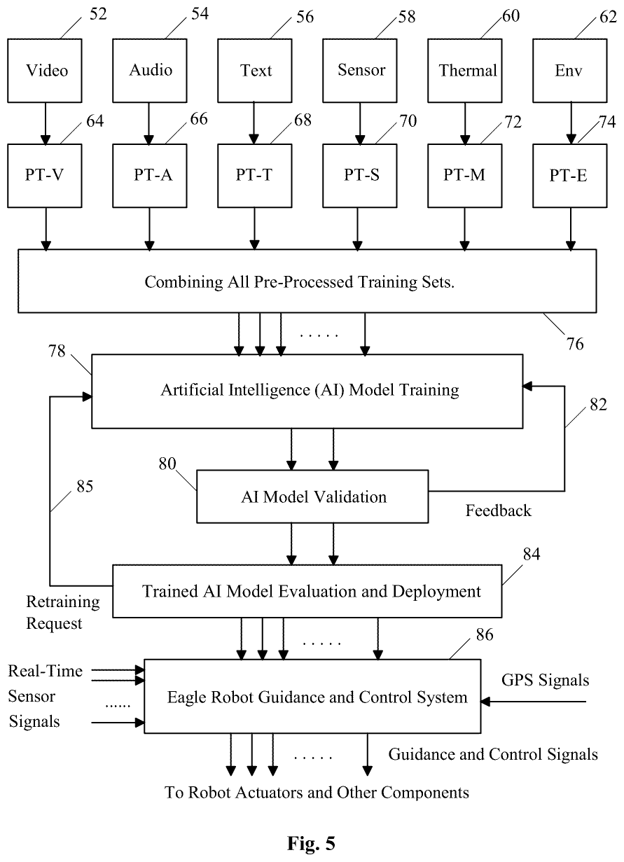

FIG. 5 is a block diagram showing the major components and workflows to develop an artificial intelligence (AI) model to be used in an eagle robot guidance and control system, according to an embodiment of this invention.

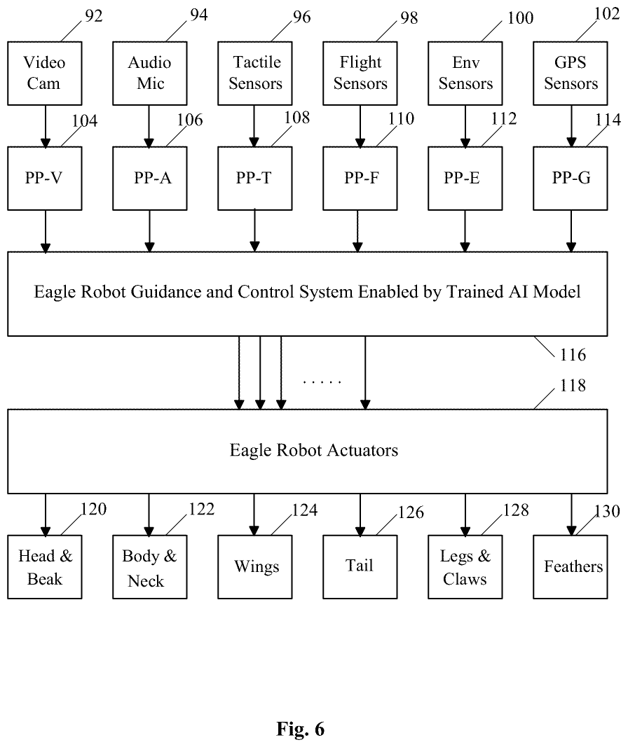

FIG. 6 is a block diagram showing the major components, including sensors, control system, actuators, and signal flows of an eagle robot guidance and control system enabled by a trained AI model, according to an embodiment of this invention.

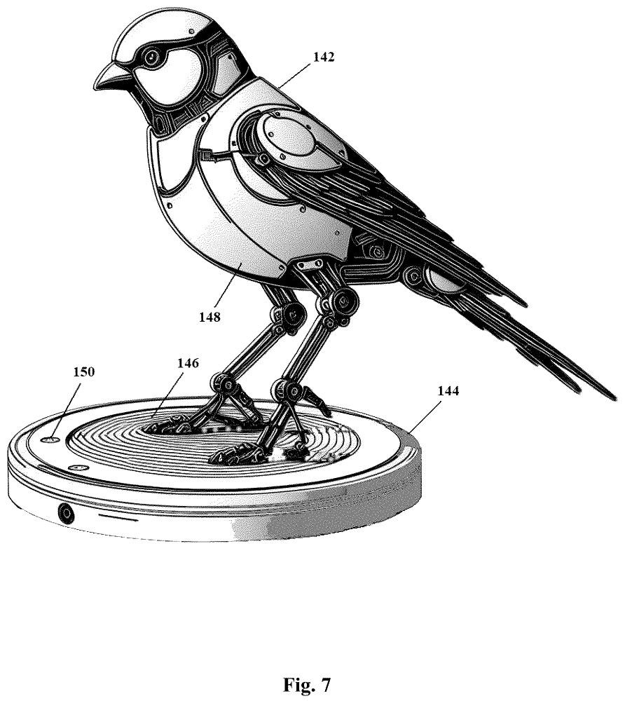

FIG. 7 is a perspective view of a robotic bird standing on a small platform for wireless battery charging, according to an embodiment of this invention.

In this patent, the term “mechanism” is used to represent hardware, software, or any combination thereof. The term “process” is used to represent a physical system or process with inputs and outputs that have dynamic relationships. The term “AI” means artificial intelligence. The term “LLM” means large language model. The term “SLM” means small language model. The term “Gen-AI” means generative AI. The term “GPT” means generative pre-trained transformer. The term “transformer” means a form of artificial neural network model used in generative artificial intelligence. The term “bird-like robot” means a robot that looks and behaves like a bird. The term “eagle-like robot” means a robot that looks and behaves like an eagle. The term “robot” or “robotic” refers to a machine resembling a human being, animal, bird, fish, or insect, capable of replicating certain movements and functions of a human being or other creatures, automatically. The term “a robotic eagle” or “an eagle robot” means an eagle-like robot. The term “a robotic bird” or “a bird robot” means a bird-like robot. The term GPS means Global Positioning System that provides users with positioning, navigation, and timing services. The term “computing processing unit” or “CPU” means a microprocessor, microcontroller, micro-control unit, or any integrated circuit capable of performing computation and executing software programs and control algorithms.

Without losing generality, a robotic eagle or an eagle-like robot can also mean a robotic bird or bird-like robot, and vice versa. All numerical values given in this patent are examples. Other values can be used without departing from the spirit or scope of this invention. The description of specific embodiments herein is for demonstration purposes and in no way limits the scope of this disclosure to exclude other not specifically described embodiments of this invention.

### DESCRIPTION

### A. Robotic Eagle for Enhancing Airport Safety

Bird strikes pose a significant threat to aircraft safety during takeoff and landing phases. Birds colliding with aircraft can cause severe damage to engines, fuselage, and critical flight systems, leading to costly repairs, flight delays, and potential safety hazards for passengers and crew. Traditional bird deterrent methods, such as loud noises and visual scare devices, often lose effectiveness as birds habituate to them over time.

A robotic eagle is an eagle-like robot, designed with advanced embodied artificial intelligence, that offers an effective solution for mitigating bird strike risks around airports. By mimicking the appearance and behavior of natural avian predators, the robotic eagle can effectively scare away birds, ensuring a safer environment for aircraft operations.

FIG. 1 is a perspective front view of a robotic eagle with all key components, according to an embodiment of this invention. The robotic eagle (10) comprises a head (12), two eyes (14), a beak (16), two wings (18), a body (20), neck (21), two legs (22), a tail (24), two claws (26), and feathers (28). The robotic eagle (10) and its main components are described in the following:

Head (12): The head houses essential sensory equipment and mechanisms. It includes various sensors and processing units to emulate the movements and functions of a real eagle's head.

Eyes (14): The eyes are equipped with advanced vision systems, including cameras and possibly infrared sensors, to provide the robot with the ability to see and analyze its environment.

Beak (16): The beak is designed to mimic the functionality of an eagle's beak, capable of pecking, grasping, and manipulating objects. It can be equipped with tactile sensors to provide feedback signals to control pecking and grasping motions.

Wings (18): The wings are equipped with multiple joints and actuators, allowing the robotic eagle to perform complex flapping and gliding motions. They are essential for flight dynamics and maneuverability.

Body (20): The central structure that supports and connects all other components. It houses the main computational units, power supply, and additional sensors for balance and orientation.

Neck (21): The neck connects the head to the body, allowing flexible movement and rotation of the head. It is equipped with actuators to provide a wide range of motion.

Legs (22): The legs provide support and mobility on the ground. They are equipped with joints and actuators for walking, perching, and stabilizing during takeoff and landing.

Tail (24): The tail is used for stability and maneuverability during flight. It can adjust its position and shape through actuators to aid in direction changes and balance.

Claws (26): The claws are designed for grasping and perching. They are equipped with actuators to provide strong, precise movements, allowing the robot to hold onto objects or surfaces securely.

Feathers (28): The feathers enhance the aerodynamic properties of the robot. They are made from lightweight, durable materials and may include sensors to provide feedback signals for the surrounding airflow and pressure.

These components work together to create a highly functional and adaptable eagle-like robot, capable of performing a variety of tasks with precision and efficiency.

Realistic Avian Predator Mimicry: The robotic eagle is engineered to closely resemble real eagles in both appearance and movement. This includes lifelike wing flapping, gliding, and perching behaviors that instinctively trigger a fear response in other birds. The robot's exterior is designed with realistic feather-like materials and coloration to enhance its visual impact on target bird species.

Autonomous Patrolling and Surveillance: Equipped with advanced sensors and AI-driven navigation systems, the robotic eagle can autonomously patrol designated areas around the airport, continuously monitoring for the presence of birds. The AI system allows the robot to identify bird species, assess their behavior, and execute appropriate deterrence maneuvers, such as swooping or diving, to scare them away.

Adaptive Deterrence Strategies: The robotic eagle employs machine learning algorithms to adapt its deterrence strategies based on the behavior and reactions of the birds. Over time, it learns the most effective methods for various species and environmental conditions. Real-time feedback from onboard sensors ensures that the robot can dynamically adjust its actions to maintain high deterrence effectiveness.

Integration with Airport Operations: The robotic eagle can be integrated into the airport's wildlife management system, working in coordination with human operators and other bird control measures. Remote monitoring and control interfaces allow airport wildlife management personnel to oversee the robot's activities, receive alerts, and manually intervene if necessary.

Safety and Efficiency: By continuously patrolling and deterring birds, the robotic eagle reduces the likelihood of bird strikes, enhancing overall aircraft safety during critical flight phases. The autonomous operation of the robot minimizes the need for human intervention, reducing labor costs and increasing efficiency in airport wildlife management.

Benefits: Enhanced Aircraft Safety: Significantly reduces the risk of bird strikes, ensuring safer takeoff and landing operations.

Effective Bird Deterrence: Mimics natural predators to effectively scare away birds, overcoming the habituation issues of traditional deterrent methods.

Autonomous Operation: Provides continuous surveillance and deterrence with minimal human intervention, improving efficiency and reducing operational costs.

Adaptive Learning: Uses Gen-AI and machine learning to adapt deterrence strategies, ensuring long-term effectiveness relating to different bird species and environmental conditions.

FIG. 2 is a perspective view of a robotic eagle flying around an airport, chasing birds away, according to an embodiment of this invention. The robotic eagle (10) is depicted in mid-flight, demonstrating its capabilities for bird deterrence in the vicinity of an airport. The following components and actions are highlighted:

Robotic Eagle (10): The robotic eagle is shown in a dynamic flying pose, with its wings (18) extended and flapping to maintain altitude and maneuverability. This illustrates the robot's ability to mimic the flight patterns of a real eagle.

Chasing Birds: The robotic eagle is actively chasing away a flock of birds from the airport area. This action demonstrates the robot's primary function in this scenario: to deter birds from entering critical zones around the airport, thereby enhancing aircraft safety during takeoff and landing.

Wings (18): The wings are depicted in a spread position, showcasing the articulated joints and actuators that allow for complex flapping and gliding motions. This capability is essential for the robot to effectively maneuver and chase birds.

Tail (24): The tail is shown adjusting its position to aid in stability and direction changes during flight. The tail's movements are controlled by actuators to enhance the robot's flight dynamics.

Eyes (14) and Head (12): The eyes and head are focused on the target birds, utilizing advanced vision systems to track and respond to their movements. This highlights the robot's sensory capabilities and its ability to process visual information in real-time.

GPS Guidance: GPS signals are sent to the robotic eagle to guide it and ensure it does not enter prohibited areas around the airport. These signals help the robotic eagle maintain its flight within designated safe zones, preventing it from interfering with aircraft operations and ensuring compliance with airport safety protocols.

Airport Environment: The background of the figure includes elements of an airport, such as runways, aircraft, and control towers. This context emphasizes the operational environment where the eagle robot is deployed for bird deterrence.

Real-Time Adaptation: The figure also implies the robot's ability to adapt to the movements of the birds and the dynamic environment of the airport, showcasing its advanced AI and sensor integration for real-time decision-making and control.

The robotic eagle represents a groundbreaking application of embodied artificial intelligence in aviation safety. By leveraging the natural instincts of birds and the advanced capabilities of AI-driven robotics, this solution offers a highly effective and sustainable method for mitigating bird strike risks around airports, ultimately contributing to safer and more reliable air travel.

### B. Bird-Like Robots for Forest Fire Monitoring

The increasing prevalence of natural disasters, such as forest fires, highlights the need for advanced, autonomous systems capable of monitoring and responding to environmental threats in real-time. Traditional monitoring methods often fall short in terms of coverage, agility, and speed, limiting their effectiveness in early detection and rapid response. Furthermore, current robotic systems lack the ability to seamlessly integrate advanced AI-driven learning and decision-making capabilities, which are crucial for navigating complex and dynamic environments like forests.

Traditional robotic designs often struggle to achieve the dynamic and adaptable capabilities seen in nature, particularly in avian species. Existing robots lack the sophisticated control systems and structural designs necessary to mimic the complex flight patterns, environmental interactions, and high-level adaptability of birds, such as eagles. This limitation restricts their effectiveness in applications requiring aerial agility, precision in maneuvering, and autonomous decision-making in dynamic environments.

FIG. 3 is a perspective side view of a bird-like robot with all key components, according to an embodiment of this invention. The robotic bird (30) comprises a head (32), two eyes (34), a beak (36), two wings (38), a body (40), a neck (41), a tail (42), two legs (44), two claws (46), and feathers (48). The robotic bird (30) and its main components are described in the following:

Head (32): The head houses essential sensory equipment and mechanisms, including various sensors and processing units. It allows the robotic bird to mimic the movements and functions of a real bird's head.

Eyes (34): The eyes are equipped with advanced vision systems, such as cameras and possibly infrared sensors, to provide the robot with the ability to see and analyze its environment.

Beak (36): The beak is designed to mimic the functionality of a real bird's beak, capable of pecking, grasping, and manipulating objects. It can be equipped with tactile sensors to provide feedback signals to control pecking and grasping motions.

Wings (38): The wings are articulated with multiple joints and actuators, allowing the robot to perform complex flapping and gliding motions. These wings are crucial for flight dynamics and maneuverability.

Body (40): The central structure that supports and connects all other components. It houses the main computational units, power supply, and additional sensors for balance and orientation.

Neck (41): The neck connects the head to the body, allowing flexible movement and rotation of the head. It is equipped with actuators to provide a wide range of motion.

Tail (42): The tail is used for stability and maneuverability during flight. It can adjust its position and shape through actuators to aid in direction changes and balance.

Legs (44): The legs provide support and mobility on the ground. They are equipped with joints and actuators for walking, perching, and stabilizing during takeoff and landing.

Claws (46): The claws are designed for grasping and perching. They are equipped with actuators to provide strong, precise movements, allowing the robot to hold onto objects or surfaces securely.

Feathers (48): The feathers enhance the aerodynamic properties of the robot. They are made from lightweight, durable materials and may include sensors to provide feedback signals for the surrounding airflow and pressure.

FIG. 4 is perspective view of a robotic bird flying in the sky, monitoring the forest and land below, according to an embodiment of this invention. In case the robotic bird (30) is used for monitoring forest fire, it includes the following key components and actions:

Robotic Bird (30): The robotic bird is shown in mid-flight, demonstrating its capabilities for aerial monitoring and surveillance. It is equipped with advanced sensors and AI to effectively monitor large areas of forest and land.

Wings (38): The wings are depicted in a spread position, enabling the robotic bird to glide and cover extensive areas efficiently. The articulated joints and actuators allow for sustained flight and maneuverability.

Eyes (34) and Head (32): The eyes and head are focused downward, utilizing advanced vision systems to scan the forest and land below. This setup allows the robotic bird to detect signs of smoke, fire, and other anomalies in real-time.

Tail (42): The tail helps stabilize the bird during flight and allows for precise adjustments in direction and altitude, enhancing its monitoring capabilities.

Feathers (48): The feathers improve the aerodynamic properties of the robotic bird, enabling it to maintain efficient and stable flight over long periods.

Forest and Land Monitoring: The robotic bird is equipped with multiple sensors, including thermal imaging sensors, to detect heat signatures and identify potential fire hotspots. This capability allows for early detection of forest fires.

Real-Time Data Transmission: As the robotic bird identifies potential fire hazards, it transmits real-time data and images to a central monitoring station. This transmission includes GPS coordinates, thermal images, and visual data, providing comprehensive situational awareness.

AI and Decision-Making: The bird's AI system processes the incoming sensor data to distinguish between normal environmental conditions and potential fire threats. It can prioritize alerts and provide recommendations for further action.

Autonomous Navigation: The robotic bird can autonomously navigate through the forest, following pre-defined flight paths or dynamically adjusting its route based on real-time data. This capability ensures thorough coverage and continuous monitoring.

Environmental Data Collection: In addition to fire monitoring, the robotic bird collects data on weather conditions, vegetation health, and other environmental factors. This information can be used for broader ecological studies and forest management.

### C. Design of Guidance and Control System for Bird-Like Robots

Leveraging the advancements in large language models (LLM) and generative artificial intelligence (Gen-AI), we describe an innovative design for bird-like robots with embodied artificial intelligence. These robots are trained using extensive video, image, and text datasets to perform complex tasks autonomously. In this section, we describe how to design a guidance and control system for robotic eagles with Gen-AI.

FIG. 5 is a block diagram showing the major components and workflows to develop an artificial intelligence (AI) model to be used in an eagle robot guidance and control system, according to an embodiment of this invention. The first layer comprises Video and Image Datasets (52), Audio Datasets (54), Text and Behavioral Annotation Datasets (56), Sensor Signal Datasets (58), (Thermal Imaging Datasets (60), and Environmental Data Datasets (62). Each of these datasets are used to provide the following functions:

Video and Image Datasets (52) capture various bird behaviors, flight patterns, and interactions with the environment to provide visual context and movement patterns.

Audio Datasets (54) record bird calls, environmental sounds, and other relevant auditory cues to provide auditory context. These datasets help the model understand the soundscape that a bird navigates, which can be crucial for certain behaviors and responses.

Text and Behavioral Annotation Datasets (56) enable the AI model developer to describe scenarios in videos, images, audios, sensor data, thermal images, and environmental information. These datasets include detailed instructions on how to respond to specific stimuli and contexts, providing semantic context, detailed explanations of actions, and specific behavioral instructions.

Sensor Signal Datasets (58) contain data from various sensors such as accelerometers, gyroscopes, and barometers, capturing the physical movements and environmental conditions. These datasets provide detailed information on the physical state and environmental conditions experienced by the bird.

Thermal Imaging Datasets (60) contain thermal videos and images that capture the heat signatures of land, smoke, and fire. This additional layer of visual data is crucial for identifying smoke, fire, and other thermal dynamics in the environment.

Environmental Data Datasets (62) record data on weather conditions, historical fire-related seasonal and environmental conditions, vegetation types, and other environmental factors. These datasets provide context on how different environmental conditions affect forest fires.

All datasets go through a data preparation step to achieve the following goals: (i) Data Cleaning: Removing any irrelevant or noisy data to ensure high-quality inputs; (ii) Data Augmentation: Generating additional training data through techniques such as translation, cropping, or rotating images (if applicable); and (iii) Data Tokenization: Converting raw text into a format suitable for the model, such as tokens or embeddings.

The prepared datasets of video, image, audio, text, sensor, thermal, and environmental information then enter the second layer, which comprises a number of pre-training mechanisms or blocks for pre-training the datasets before they can be used for AI model training. Here, “block” refers to a mechanism that includes hardware, software, or a combination of both to perform specific functions.

Video and Image Datasets (52) enter Pre-training Block PT-V (64), Audio Datasets (54) enter Pre-training Block PT-A (66), Text Datasets (56) enter Pre-training Block PT-T (68), Sensor Datasets (58) enter Pre-training Block PT-S (70), Thermal Imaging Datasets (60) enter Pre-training Block PT-M (72), and Environmental Data Datasets (62) enter Pre-training Block PT-E (74). The pre-training process in each block is designed to clean and prepare the datasets for subsequent AI model training.

The pre-training process typically includes the following steps: (i) Model Initialization: Setting up the model with initial weights, often based on a pre-existing, pre-trained model; (ii) Training on a Large Corpus: Training the model on a large, diverse dataset to learn general language patterns and representations; and (iii) Using Transformers: Implementing transformer architectures, a type of AI neural network widely used in large language model (LLM) training, to efficiently process and generate sequences.

All pre-trained datasets are then combined in Block (76) to integrate the cleaned and pre-trained datasets from the individual pre-training blocks. This integration ensures that the datasets are synchronized and formatted appropriately for the next stage of the AI model training process.

The combined datasets then enter Blocks 78 and 80 to perform AI model training and validation. This training process starts with using a commercially available or open-source large language model (LLM) base model. Utilizing such a base model simplifies and streamlines the actual secondary model training and fine-tuning, making the entire process more efficient and manageable. Secondary model training and fine-tuning is the step of adapting the base model to specific tasks by further training it on task-specific datasets. This involves adjusting the model's weights and hyperparameters to optimize its performance for the desired applications.

Neural network weights are the parameters within the model that are adjusted during training to minimize the error in predictions. They determine the strength of the connection between neurons in different layers of the network. Hyperparameters, on the other hand, are the settings that define the overall structure and behavior of the model, such as learning rate, batch size, and the number of layers. These are set before training begins and can significantly impact the model's performance and training efficiency.

The secondary AI model training, fine-tuning, and validation may require substantial computing power and time, involving multiple recurring steps until the model training can be considered complete based on certain model convergence and validation criteria. These steps typically include the following: (i) Task-Specific Training: Training the pre-trained model on a specific dataset tailored to the desired application (e.g., classification, translation); (ii) Adjusting Hyperparameters: Tweaking learning rates, batch sizes, and other parameters to optimize performance for the specific task; and (iii) Validation: Continuously validating the model on a separate validation set to monitor performance and prevent overfitting.

Overfitting means that the model learns the training data too well, including noise and minor details, which negatively impacts its performance on new, unseen data. It results in a model that performs well on the training data but poorly on validation or test data, indicating that it has not generalized well to new situations.

During the Validation (80) step, feedback information is sent back through Step (82) to maintain a continuous relationship between the AI Model Training block (78) and the AI Model Validation block (80). This iterative process ensures that the model training continues until it meets the required model convergence and validation criteria, ensuring robust and accurate performance.

After the AI model is validated, it enters Block 84 for model evaluation and deployment. The evaluation may include: (i) Performance Metrics: Assessing the model using metrics like accuracy, precision, recall, F1 score, and loss to evaluate its effectiveness. The F1 score is a measure of a model's accuracy that considers both precision (the number of true positive results divided by the number of all positive results, including those not identified correctly) and recall (the number of true positive results divided by the number of positives that should have been identified). It is the harmonic mean of precision and recall, providing a single metric that balances both concerns; and (ii) Error Analysis: Analyzing errors and misclassifications to understand model weaknesses and areas for improvement.

The deployment should include: (i) Model Optimization: Compressing and optimizing the model for faster inference and lower resource usage through techniques such as pruning and quantization. Pruning involves removing less important weights in the neural network to reduce its size and complexity, while quantization reduces the precision of the numbers used to represent the model's parameters, making the model smaller and faster without significantly affecting performance; (ii) Integration: Integrating the model into the target application or system to ensure it functions correctly in the intended environment; and (iii) Monitoring and Maintenance: Continuously monitoring the model's performance in real-world scenarios and retraining or updating as necessary to maintain and improve performance. The request for model retraining or updating is shown in Block 85, ensuring that the model remains effective and up-to-date.

All of the steps from gathering datasets to AI model training, validation, and deployment that can be used in this embodiment are any of the known techniques described in the book, “Large Language Models in Action: Design, Build, and Deploy Intelligent LLM Applications” by Liam Sturgis, independently published in April 2024, wherein the book and its contents are herein expressly incorporated by reference in their entirety. All software programs, AI models, and control algorithms are executed using computing processing units (CPU). The term “computing processing unit” or “CPU” means a microprocessor, microcontroller, micro-control unit, or any integrated circuit capable of performing computation and executing software programs and control algorithms.

The trained AI model will be integrated with the Eagle Robot Guidance and Control System (86) to be described in FIG. 6.

FIG. 6 is a block diagram showing the major components, including sensors, control system, actuators, and signal flows of an eagle robot guidance and control system enabled by a trained AI model, according to an embodiment of this invention.

A guidance and control system for an eagle robot is a sophisticated mechanism that directs the robot's movements and actions in real-time. The guidance part involves determining the optimal path and actions for the robot based on inputs from various sensors, such as video cameras, audio microphones, and GPS sensors. This includes processing environmental data to navigate obstacles, adjust flight paths, and execute specific tasks. The control aspect translates these guidance decisions into precise commands for the actuators, ensuring smooth and accurate movements of the robot's head, wings, tail, and other parts. Together, this system enables the eagle robot to perform complex tasks autonomously and efficiently.

On the first layer of the Eagle Robot Guidance and Control System, it comprises Video Cameras (92), Audio Microphones (94), Tactile Sensors (96), Flight Sensors (98), Environmental Sensors (100), and GPS Sensors (102). The purpose of using these sensors are described in the following:

Video Cameras (92): Capture visual data from the environment to provide real-time video feeds for navigation and analysis.

Audio Microphones (94): Record ambient sounds and audio cues to aid in environmental awareness and communication.

Tactile Sensors (96): Detect physical interactions and contact, providing feedback on touch and pressure.

Flight Sensors (98): Measure flight dynamics such as speed, altitude, and orientation to ensure stable and controlled flight.

Environmental Sensors (100): Gather data on environmental conditions such as temperature, humidity, and air quality.

GPS Sensors (102): Provide precise location data for navigation and mapping purposes.

Each of these sensors may include specialized hardware and software to process the collected data effectively.

The signals from video cameras (92), audio microphones (94), tactile sensors (96), flight sensors (98), environmental sensors (100), and GPS sensors (102) then enter the second layer of the system. This layer comprises signal pre-processing mechanisms for signal cleanup and validation before they can be used for guidance and control.

As shown in FIG. 6: Video signals (92) enter Preprocessing Block PP-V (104); Audio signals (94) enter Preprocessing Block PP-A (106); Tactile signals (96) enter Preprocessing Block PP-T (108); Flight sensor signals (98) enter Preprocessing Block PP-F (110); Environmental sensor signals (100) enter Preprocessing Block PP-E (112); GPS sensor signals (102) enter Preprocessing Block PP-G (114). Each preprocessing block is responsible for cleaning and validating the respective signals to ensure they are accurate and reliable for the subsequent guidance and control processes.

The output of each preprocessing block then enters the Eagle Robot Guidance and Control System Enabled by Trained AI Model (116) as input signals. This system produces output signals based on guidance and control algorithms in real-time to manipulate the Eagle Robot Actuators (118). These actuators guide and control the motions of various parts of the eagle robot, including the Head and Beak (120), Body and Neck (122), Wings (124), Tail (126), Legs and Claws (128), and Feathers (130). This real-time guidance and control system ensures that the eagle robot can perform its intended functions effectively and accurately.

### D. Wireless Battery Charging for Bird-Like Robots

Since a robotic eagle or bird flies and performs its tasks autonomously without human interaction and remote control, charging the battery inside the robot body becomes a crucial part of the design.

FIG. 7 is a perspective view of a robotic bird standing on a small platform for wireless battery charging, according to an embodiment of this invention.

A wireless battery charging system is designed to charge the robotic bird's battery wirelessly, ensuring it can perform its tasks autonomously without human interaction or remote control. In this system, the robotic bird can simply stand on the battery charger, as illustrated in FIG. 7, which comprises the following components:

Robotic Bird (142): The robotic bird that needs to charge its battery.

Charging Platform (144): A platform designed to accommodate the robotic eagle, enabling it to stand in a stable position while charging.

Wireless Charging Coil (146): Embedded within the charging platform, this coil generates an electromagnetic field to transfer energy wirelessly to the robotic eagle's battery.

Receiving Coil (148): Integrated within the body of the robotic eagle, this coil receives the electromagnetic energy from the charging platform and converts it into electrical energy to charge the battery.

Charging Control Unit (150): A control unit that manages the charging process, ensuring the battery is charged efficiently and safely. It may include features such as overcharge protection and charging status indicators.

Since the robotic bird is likely to operate in remote areas, the battery charging station should be situated in such a location that the robotic bird can easily reach and land for resting and charging. The power supply options for the battery charging station include: (i) Grid AC Power: Utilizing existing grid infrastructure to provide consistent electrical power; (ii) Off-Grid Solar Power with Battery Backup: Harnessing solar energy through solar panels, with battery storage to ensure power availability during nighttime or cloudy conditions; (iii) Wind Power with Battery Backup: Generating power through wind turbines, with battery storage to maintain a steady power supply when wind conditions are variable; and (iv) Combination of Grid AC Power, Solar Power, and Wind Power: Integrating multiple power sources to enhance reliability and ensure continuous power availability regardless of environmental conditions.

### E. Conclusion

The motivation to develop a robotic eagle and a bird-like robot empowered by generative artificial intelligence (Gen-AI) fits the mega-trend of the 4th Industrial Revolution, where everything will be smart. In the not-too-distant future, humanoid robots and robotic creatures will be deployed on a large scale to enhance various sectors, including industrial automation, environmental monitoring, disaster response, wildlife conservation, agriculture, healthcare, and public safety. These advancements will lead to more efficient resource management, quicker emergency responses, better protection of natural habitats, increased industrial and agricultural yields, and improved safety and security in public spaces, profoundly benefiting our society.

The applicant of this patent has many years of experience in technology innovation in industrial automation, renewable energy, and artificial intelligence. Our goal is to contribute to the exciting technology transformation enabled by generative artificial intelligence in various applications that can make a significant impact on our society and the world.

1. A bird-like robot comprising:
a) a body comprising:
(i) a head;
(ii) a plurality of eyes;
(iii) a body structure to house or connect robot components;
(iv) a plurality of wings;
(v) a plurality of legs with claws; and
(vi) a tail;
b) a plurality of sensors configured to capture environmental data, including at least one video camera, at least one audio microphone, and at least one flight sensor;
c) a power supply;
d) a guidance and control system comprising a trained artificial intelligence (AI) model, wherein the guidance and control system is configured to process the environmental data captured by the sensors and generate control signals; and
e) a plurality of actuators responsive to the control signals generated by the guidance and control system, wherein the actuators are configured to manipulate at least the wings, tail, and legs, to perform autonomous flight and task execution.

2. The bird-like robot of claim 1, wherein the plurality of eyes comprises at least one camera and one infrared sensor.

3. The bird-like robot of claim 1, further comprising a wireless communication module configured to transmit data captured by the sensors to a remote monitoring station.

4. The bird-like robot of claim 1, wherein the plurality of sensors further comprises environmental sensors configured to measure temperature, humidity, and air quality.

5. The bird-like robot of claim 1, wherein the guidance and control system comprises a navigation module configured to use GPS signals for determining the location and flight path of the robot.

6. The bird-like robot of claim 1, wherein the power supply comprises a battery and a wireless charging system allowing the robot to charge the battery autonomously.

7. The bird-like robot of claim 1, wherein the wings and tail further comprise feathers, and actuators are configured to adjust the wings, tail, and feathers to mimic the flight dynamics of a bird.

8. A guidance and control system of a bird-like robot, comprising:
a) a plurality of sensors configured to capture environmental data, including at least one video camera, at least one audio microphone, and at least one flight sensor;
b) a trained artificial intelligence (AI) model configured to process the environmental data captured by the sensors and provide robot flight and motion guidance;
c) a computing processing unit configured to execute the AI model, control algorithms, and provide guidance commands and control signals; and
d) a plurality of actuators responsive to the control signals, wherein the actuators are configured to manipulate parts of the bird-like robot to perform autonomous flight and task execution.

9. The guidance and control system of claim 8, wherein the system is configured to perform obstacle detection and avoidance using data from the sensors.

10. The guidance and control system of claim 8, wherein the plurality of sensors further includes environmental sensors configured to measure temperature, humidity, and air quality.

11. The guidance and control system of claim 8, wherein the AI model is further configured to optimize flight paths based on real-time environmental data.

12. The guidance and control system of claim 8, further comprising a wireless communication module configured to transmit data to, and receive data from, a remote monitoring station.

13. The guidance and control system of claim 8, further comprising a GPS module configured to provide location data for navigation and flight control.

14. The guidance and control system of claim 8, wherein the plurality of actuators are further configured to adjust wings, a tail, and legs of the bird-like robot to mimic the flight dynamics of a real bird.

15. A wireless battery charging system for a bird-like robot, comprising:
a) a charging platform configured to accommodate the bird-like robot in a stable position for charging;
b) a wireless charging coil embedded within the charging platform, configured to generate an electromagnetic field for energy transfer;
c) a receiving coil integrated within the bird-like robot, configured to receive the electromagnetic energy from the charging platform and convert it into electrical energy to charge a battery of the robot; and
d) a charging control unit configured to manage the charging process, including monitoring battery status and ensuring safe and efficient energy transfer.

16. The wireless battery charging system of claim 15, wherein the charging platform is powered by a combination of power sources selected from the group consisting of grid AC power, off-grid solar power with battery backup, and wind power with battery backup.

17. The wireless battery charging system of claim 15, wherein the charging control unit is configured to communicate with the bird-like robot to provide real-time updates on the charging status and battery health.

18. A method for autonomously operating a bird-like robot, comprising the steps of:
a) capturing environmental data using a plurality of sensors, including at least one video camera, at least one audio microphone, and at least one flight sensor;
b) processing the captured environmental data using a trained artificial intelligence (AI) model and a control system to generate guidance and control signals;
c) executing the guidance and control signals to control flight and movements of the bird-like robot; and
d) manipulating parts of the bird-like robot, including wings, a tail, and legs, using a plurality of actuators in response to the control signals to perform autonomous flight and task execution.

19. The method of claim 18, further comprising a step of performing obstacle detection and avoidance using the environmental data captured by the sensors to ensure safe navigation of the bird-like robot.

20. The method of claim 18, further comprising a step of wirelessly charging a battery of the robot using a wireless charging system, wherein the robot autonomously docks with a charging platform to replenish its power supply.
